(19) United States
(12) Patent Application Publication
(10) Pub. No.: US 2009/0192285 A1
(43) Pub. Date: Jul. 30, 2009

(54) Method and device for the production of polyesters and copolyesters

(76) Inventors: Fritz Wilhelm, Karben (DE); Stefan Deiss, Harxheim (DE)

Correspondence Address: K.F. ROSS P.C., 5683 RIVERDALE AVENUE, SUITE 203 BOX 900, BRONX, NY, 10471-0900, US

(21) Appl. No.: 10/585,470

(22) PCT Filed: Dec. 14, 2004
(86) PCT No.: PCT/EP04/14214

§ 371 Date: Jul. 6, 2006

(30) Foreign Application Priority Data
Feb. 27, 2004 (DE) 10 2004 010 146.9

(51) Int. Cl. C08G 63/78; B01J 19/00

(52) U.S. Cl. 528/272; 528/271; 422/134

(57) ABSTRACT

Disclosed is a method for producing polyesters by means of esterification or re-esterification, precondensation of the esterified/re-esterified product, and polycondensation of the precondensed product at a pressure of 0.2 to 500 mbar and a temperature of 230 to 330° C. According to said method, the vapors formed during precondensation and polycondensation are condensed and the obtained cooled diol is redirected into the condensation stage. In order to improve the degree of separation, the vapors are directed into a bottomless direct contact condenser, the base of which is immersed into the top funnel-shaped section of a barometrically dipped downpipe so as to form an annular space, cooled diol is sprayed into the vapors in the top section of the direct contact condenser, the remaining vapors are recovered via the annular space, and the formed polymer aggregates are removed.

The invention relates to a method and a device for producing polyesters or copolyesters by esterification of dicarboxylic acids and diols or by re-esterification of dicarboxylic acid esters and diols in multiple reaction pressure stages, precondensation of the esterification/re-esterification product in at least one reaction pressure stage and polycondensation of the precondensation product in at least one reaction pressure stage by setting the pressure in the reaction pressure stages for precondensation and polycondensation in the range of 0.2 mbar to 500 mbar and setting the temperature in the range of 230° C. to 330° C., condensing the vapors formed in precondensation and polycondensation in a condensation stage and cooling the resulting diol and recycling it back to the condensation stage and removing excess diol and sending it to the process.

The vapors formed in the production of polyethylene terephthalate (PET) from terephthalic acid (TPA) or dimethyl terephthalate (DMT) and ethanediol (EG) in vacuo contain, in addition to cleavage diol, low-boiling byproducts and degradation products such as water, methanol, acetaldehyde, which, together with leakage air, can result in a comparatively high molar amount of inert uncondensable constituents in the vapor mixture. Due to these inert ingredients, the intensity of the heat transfer in condensation of the vapors is limited. Since the flow of vapors in the condensation plant is laminar, cooling of the vapors to the dew point of the diol requires a much longer time comparatively than the actual condensation. In addition to the low-boiling byproducts and degradation products, monomers and oligomers which sublime on the cold walls of the condensation system or dissolve in the circulating diol are also distilled off to a limited extent. However, the dissolved monomers and oligomers have a tendency to crystallize out on areas of the wall and/or pipelines of the condensation system which are subject to supercooled or turbulent flows, so that these areas interfere with the cooling of the diol or clog up the lines when using spray nozzles. In addition, fine aerosol droplets of product entrained in the vapors are deposited in the transitional area of the vapor inlet line to the cold unwetted condenser wall and then solidify, forming large deposits which interfere with trouble-free operation of the condensation system and/or stable polymer production.

U.S. Pat. No. 2,793,235 A discloses a process for producing polyesters in which the vapors are charged centrally from above to a spray condenser having an unheated conical cover with four spray nozzles and condensate is removed centrally at the bottom. The remaining vapor residues are removed laterally and sent to a droplet separator (demister) with wetted wire mesh and a downstream separator (catch pot), which are connected to a joint EG circuit with an immersion tank, circulating pump and cooler. To prevent clogging of the condenser system with oligomers, an ester-free EG is produced by alkaline saponification of ester. In this process, there are losses of ester, which are a disadvantage; the corresponding disposal of the alkali salts of TPA is associated with a considerable effort. A considerable drop in pressure and a loss of energy also occur due to the addition of droplet separators with a downstream separator. Product deposits consisting of oligomers are formed on the cold cover of the spray condenser and on the nozzles mounted therein, causing an increased susceptibility of the spray condenser to problems. According to a further embodiment that has become known in the technical world in the meantime, the cover of the spray condenser is heatable and is periodically cleaned mechanically, while the separator and the droplet separator are replaced by a second spray condenser.

In the process described in German Patent DE-A-1503688 and U.S. Pat. No. 3,468,849 A for production of PET, the formation of residues in the condenser is prevented by having the vapors flow laterally into the heated head area of a vertical cylinder that is open at the bottom and develops into an unheated downpipe equipped with a first ring of spray nozzles. A rotating coaxial cleaning coil is guided to the lower end of the heated cylinder. The lower end of the downpipe is surrounded by a cylinder with an outlet cone, forming an outer annular space. The remaining vapors are deflected at the end of the downpipe into the outer annular space, passing through a second ring of spray nozzles there. The remaining vapors are sent from the upper end of the annular space to a downstream compressor. It is a disadvantage here that with such a spray condenser, sublimation of the oligomers contained in the vapors may occur in the transitional area from the heated head area to the unheated downpipe. With a horizontal orientation of the spray nozzles, the dwell time of individual droplets of the cooling spray is extremely short and the spray volume is small, so the cooling effect is limited. In the outer annular space between the downpipe and the cylinder surrounding the downpipe, it is technically difficult to produce a spray without any gaps, so it is impossible to achieve optimum separation and residual vapors free of oligomers.

It also known that the vapor flow can be introduced vertically from above into a horizontal container partially filled with circulating diol and with a scraper mechanism running along the edges, so that the vapors are pre-purified in this container and/or deflected into a vertical multistage falling film condenser and cooled and condensed in countercurrent with the washing diol. The remaining vapors are discharged at the head of the condenser and sent to a vacuum pump. Apart from the fact that a comparatively large amount of circulating diol is required in this process, there are partially unwetted wall areas in the condenser and increased flow resistances in the condenser system which constitute operational and energetic disadvantages. However, the mechanical and technical complexity is a decisive disadvantage.

The object of the present invention is to achieve a high degree of separation of the condensable constituents contained in the vapors formed in the process described above and to achieve this separation in the condensation stage with a limited pressure drop and energy loss and without the use of mechanical cleaning equipment.

This object is achieved by the fact that the cooled diol carried in circulation is sprayed out of the openings in spray nozzles at the edges on at least two planes one above the other in the head area of the direct-contact condenser and into the vapors introduced into the head area of a bottomless direct-contact condenser which is immersed at its foot area into the upper enlarged section that is widened like a funnel of a barometrically submerged downpipe, forming an annular space that is sealed at the top; the vapor residues are discharged through the annular space between the wall of the direct-contact condenser and the wall of the section of the downpipe expanded in the form of a funnel; and the fine lumps of polymer aggregates formed in the direct-contact condenser are washed together with the diol into the downpipe and removed from the condensation stage.

With regard to the desired effect of the sprayed diol, it is advantageous if, according to another inventive feature, the average droplet diameter dₛ of the sprayed diol, determined according to Sauter, amounts to 0.5 mm to 2.5 mm and the average droplet flight time of the sprayed diol is 0.05 to 0.5 sec.

The vapor residues sent from the direct-contact condenser are then compressed to a higher pressure and proportionally condensed further.

The fine lumps of polymer aggregates are separated as screening residue and/or are discharged together with the excess diol from the immersion tank of the downpipe.

According to a special embodiment of the invention, the inside wall of the direct-contact condenser is completely wetted with a trickle film of recycled diol to prevent sublimation of oligomers and monomers in cold zones of the direct-contact condenser. The trickle film is reinforced and/or stabilized by the sprayed diol and at the lower edge of the direct-contact condenser it is transferred to a vertical, self-contained falling film extending to the funnel wall of the downpipe, so that the space for the effect of the sprayed diol extends to the funnel end of the falling film.

With the device for performing the method, the openings in the spray nozzles in one plane are offset with respect to those in a neighboring plane around the circumference of the direct-contact condenser. As a result of this measure, the entire cross section of the direct-contact condenser is covered with recycled diol, so that in the event of failure of one spray nozzle, there is a slight decline in droplet frequency locally but no gaps are formed. Due to the superimposed spray patterns of the spray nozzles, extensive homogeneity of the diol spray and efficient heat exchange between the hot vapors and the cold diol are achieved in addition to optimum utilization of the space of the direct-contact condenser. Due to the increased droplet density of the sprayed diol in the upper section of the direct-contact condenser, accelerated cooling of the vapors to the dew point of the diol is achieved.

Optimization of the effects described above is achieved if, according to other features of the invention, the spray patterns formed by the spray nozzles are in the shape of a solid cone with an angle of divergence in the range of 60° to 140° and within the scope of the inventive embodiment, the solid cones formed by the spray nozzles in the upper plane at the head end have an angle of divergence in the range of 60° to 120° and the solid cones formed by the spray nozzles in the plane below that have an angle of divergence in the range of 100° to 140°.

The axes of the solid cones intersect the axis of the direct-contact condenser at an angle in the range of 5° to 75°, whereby the axes of the solid cones formed by the spray nozzles in the upper plane in the head area intersect the vertical axis of the direct-contact condenser at an angle in the range of 5° to 60°, and the axes of the solid angles formed by the spray nozzles in the plane beneath that intersect the vertical axis of the direct-contact condenser at an angle of 50° to 75°.

As a rule, the solid cones formed by the spray nozzles are circular. As an alternative, the spray nozzles arranged in at least one of the planes at the head end may have the spray pattern of a rectangular solid cone.

To reduce the amount of circulating diol, fresh diol is atomized by means of a liquid high-pressure nozzle, preferably a misting nozzle, with an atomization pattern of a hollow cone whose axis is approximately coaxial with the vertical axis of the direct-contact condenser, the angle of divergence in atomization being in the range of 15° to 45° in the curved area of the vapor line to the direct-contact condenser upstream from the opening of the pipe into the direct-contact condenser almost vertically in crosscurrent with the falling vapors. In this way, most of the vapors are subjected to an additionally accelerated cooling by evaporation of extremely fine droplets. Furthermore, a definite reduction in the demand for diol is achieved.

With the direct-contact condenser according to this invention, at least three openings of spray nozzles are provided in each of the planes in which recycled diol is sprayed, whereby the openings in the spray nozzles of one plane are arranged so they are each offset with respect to those of the second plane as seen from above by half a central angle between the two neighboring spray nozzles of one plane.

A special embodiment of the device consists of the fact that the cover of the direct-contact condenser and the vapor tube arranged in the inlet opening of the cover are heatable.

According to a special feature of the invention, the spray nozzles of the upper plane at the head are positioned in the cover, preferably with thermal insulation.

The spray nozzles and the liquid pressure nozzle are expediently mounted over a lance or a valve.

To prevent deposits of solidifying polymer on the outlet openings of the spray nozzles below the vapor opening into the direct-contact condenser, the end of the vapor tube arranged in the cover of the direct-contact condenser protrudes beyond the inside wall of the cover and has a sharp drip edge from which strands of polymer formed in the vapor tube go directly into the spray space of the direct-contact condenser, where they solidify to form larger aggregates to a limited extent and are washed out with the diol through the downpipe, collected in the immersion tank of the downpipe and discharged separately from there or removed together with the excess diol. Alternatively, a concentric ring outside of the vapor tube is mounted as a drip edge on the inside wall of the cover.

For removal of the vapor residues from the direct-contact condenser, it is advantageous for the foot edge of the direct-contact condenser to be provided with a recess diametrically opposite the residual vapor drain out of the annular space between the wall of the direct-contact condenser and the wall of the funnel-shaped enlargement of the barometrically submerged downpipe. Alternatively, the foot edge there may be provided with sawtooth profiles either entirely or in part.

According to an additional feature of the invention, a peripheral ring nozzle is mounted on the inside of the direct-contact condenser in the upper cylindrical edge area.

The invention is explained in greater detail below and is illustrated as an example in the drawings, which show:

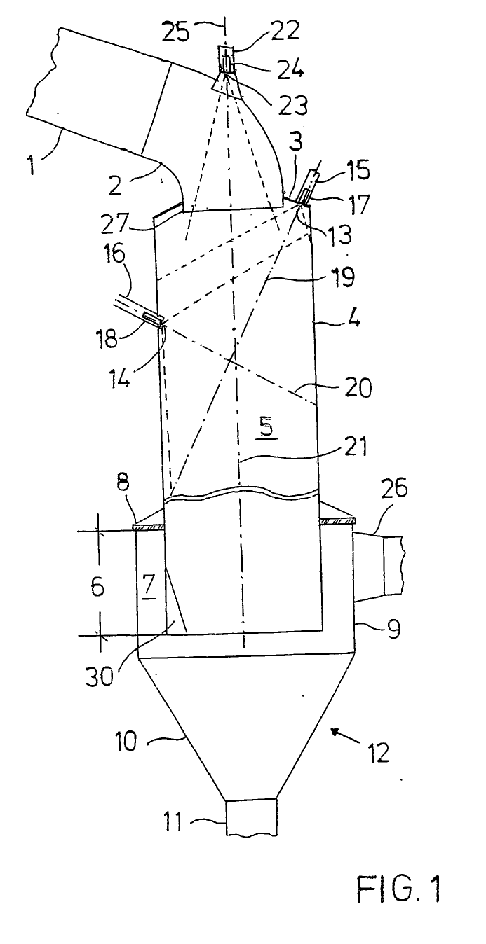

FIG. 1 a longitudinal section through a direct-contact condenser having a downstream barometrically submerged downpipe,

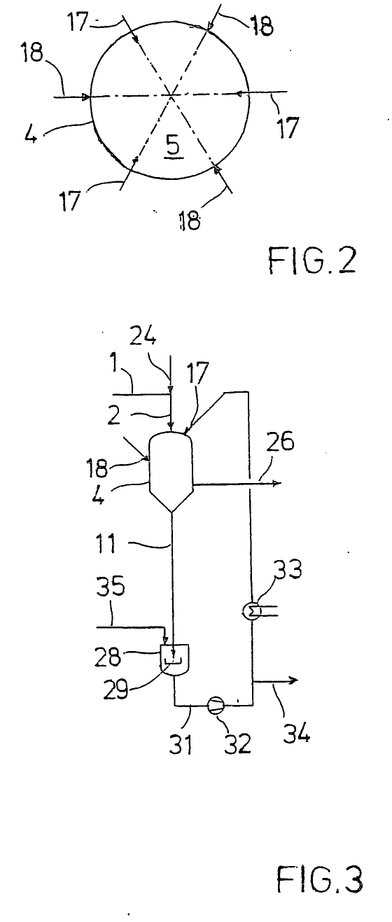

FIG. 2 a schematic top view of the direct-contact condenser having the spray nozzles shown in the drawing,

FIG. 3 a schematic flow chart of the process.

Vapors containing small amounts of oligomers and polymers at a temperature of approximately 280° C., supplied through the pipeline (1), are introduced into the spray space (5) of the direct-contact condenser (4) at a vacuum of 1 mbar through the pipeline bend (2) which develops into the vapor opening situated in the heatable cover (3) of the direct-contact condenser (4). The direct-contact condenser (4) is immersed at its foot area (6) into a funnel (12) consisting of a cylindrical section (9) and a section (10) in the shape of a truncated cone developing into the former at the lower end and connected to a barometrically submerged downpipe (11), forming an annular space (7) that is closed at the top and has a flat cover (8). Cooled recycled diol is sprayed into the vapors through the openings (13, 14) of spray nozzles (17, 18) situated in the jacketed tubes (15, 16) mounted in the cover (3) and in the upper area of the direct-contact condenser (4), with the spray pattern of solid cones having an angle of divergence of 85° and/or 120°, their axes (19, 20) intersecting the axis (21) of the direct-contact condenser (4) at an angle of 25° and/or 65°. Fresh diol is atomized in crosscurrent/cocurrent with the vapors through the opening (23) in a misting nozzle (24) which is situated in the pipeline bend (2) at the end of a sheathing pipe (22) and has the atomization pattern of a hollow cone with an angle of divergence of 35°, its axis (25) aligned approximately coaxially with the axis (21) of the direct-contact condenser (4). The vapor residues remaining after condensation are vented through the annular space (7) between the foot section (6) of the direct-contact condenser (4) and the cylindrical section (9) of the funnel (12) and discharged through the pipeline (26). The polymer melt that separates on the inside wall of the pipeline bend (2) flows to the protruding end of the pipe mouth, designed as a drip edge (27), and drips by strands into the spray space (5) of the direct-contact condenser (4). The fine lumps of polymer aggregates solidifying in the direct-contact condenser (4) are sent together with the diol through the section (10) of the funnel (12) in the form of a truncated cone into the barometrically submerged downpipe (11) and are collected by a screen (29) arranged in the submerged tank (28) of the downpipe (11). The wall of the direct-contact condenser (5) in the edge area diametrically opposite the pipeline (26) is provided with a passage (30), so that uncontrolled direct venting of vapor residues laden with diol is prevented.

The height of the diol column in the downpipe (11) depends on pressure p prevailing in the direct-contact condenser (4). At an outside air pressure p₀ in the submerged container (28), the diol column of density ρ in the downpipe (11) achieves a differential height H=[p₀−p]/ρg. Diol is conveyed out of the submerged tank (28) by the pump (32) and through the circulating line (31) via the cooler (33) to the openings (13, 14) in the spray nozzles (17, 18). Condensed diol passes through the downpipe (11) and fresh diol added via the misting nozzle (24) goes back into the submerged tank (28). Excess diol is removed through the line (34). As an alternative, fresh diol is sent to the submerged tank (28) through the line (35).

1. A process for producing polyesters or copolyesters by esterification of dicarboxylic acids and diols or by re-esterification of dicarboxylic acid esters and diols in multiple reaction stages, precondensation of the esterification/re-esterification product in at least one reaction stage and polycondensation of the precondensation product in at least one reaction stage by setting the pressure in the precondensation stage and in the polycondensation stage to be in the range of 0.2 to 500 mbar and setting the temperature at 230° to 330° C., condensing the vapors formed in precondensation and polycondensation in a condensation stage and recycling the resulting cooled diol back to the condensation stage and removing excess diol and sending it back to the process,
characterized in that
circulating cooled diol is sprayed into the vapors introduced into the area at the head of a bottomless direct-contact condenser (4) which is submerged at its foot end (6) into the upper funnel-shaped section (9, 10) of a barometrically submerged downpipe (11), forming an annular space (7) that is closed at the top, said cooled diol being sprayed out of the openings (13, 14) at the edges of spray nozzles (17, 18) situated on at least two planes one above the other in the area at the head end; the vapor residues are discharged through the annular space formed between the wall of the direct-contact condenser and the wall of the section of the downpipe that widens in the shape of a funnel; the fine lumps of polymer aggregates formed in the direct-contact condenser are flushed together with the diol into the downpipe and are removed from the condensation stage.

2. The process according to claim 1,
characterized in that
the average droplet diameter dₛ of the sprayed diol, determined according to Sauter, is in the range of 0.5 to 2.5 mm.

3. The process according to any one of claims 1 and 2,
characterized in that
the average droplet flight time of the sprayed diol is 0.05 to 0.5 sec.

4. The process according to any one of claims 1 through 3,
characterized in that
the vapor residues discharged from the direct-contact condenser (4) are compressed to a higher pressure and are proportionately condensed further.

5. The process according to any one of claims 1 through 4,
characterized in that
the fine lumps of polymer aggregates in the submerged tank (28) of the downpipe (11) are separated by screening and/or are discharged from the submerged tank (28) together with the excess diol.

6. The process according to any one of claims 1 through 5,
characterized in that
the inside wall of the direct-contact condenser (4) is wetted completely with a trickle film of recycled diol to form a self-contained film.

7. A device for continuous production of polyesters or copolyesters by esterification of dicarboxylic acids and diols or by re-esterification of dicarboxylic acid esters and diols in multiple reaction stages, precondensation of the esterification/re-esterification product in at least one reaction stage and polycondensation of the precondensation product in at least one reaction stage by setting the pressure in the precondensation stage and in the polycondensation stage to be in the range of 0.2 to 500 mbar and the temperature in the range of 230° to 330° C.; the vapors formed in precondensation and polycondensation are condensed in a condensation stage and the resulting diol is cooled and recycled back to the condensation stage and excess diol is discharged and sent to the process, whereby circulating cooled diol is sprayed into the vapors introduced into the area at the head end of a bottomless direct-contact condenser (4) which is immersed at its foot area (6) forming a section (12) of a barometrically submerged downpipe (11) that is widened like a funnel at the upper end, forming an annular space (7) that is closed at the top, said vapors being sprayed out of openings (13, 14) in spray nozzles (17, 18) at the edge on at least two planes, one above the other in the area at the head end; the vapor residues are discharged through the annular space formed between the wall of the direct-contact condenser and the wall (9) of the section of the downpipe that widens in the shape of a funnel; the fine lumps of polymer aggregates formed in the direct-contact condenser are flushed with the diol into the downpipe and removed from the condensation stage,
characterized in that
the openings (13) in the spray nozzles (17) in one plane are arranged on the circumference of the direct-contact condenser (4) so that they are offset with respect to the openings (14) in the spray nozzles (18) in the neighboring plane.

8. The device according to claim 7,
characterized in that
the spray patterns formed by the spray nozzles are in the shape of a solid cone having an angle of divergence of 60° to 140°.

9. The device according to claim 8,
characterized in that
the solid cones formed by the spray nozzles (13) in the upper plane at the head end form an angle of divergence in the range of 60° to 120° and the solid cones formed by the spray nozzles (14) in the plane beneath that have an angle of divergence in the range of 100° to 140°.

10. The device according to any one of claims 7 through 9,
characterized in that
the axes (19, 20) of the solid cones formed by the spray nozzles (13, 14) intersect the vertical axis (21) of the direct-contact condenser (4) at an angle in the range of 5° to 75°.

11. The device according to claim 10,
characterized in that
the axes (19) of the solid cones formed by the spray nozzles (13) situated in the upper plane on the head end intersect the vertical axis (21) of the direct-contact condenser (4) at an angle in the range of 5° to 60°, and the axes (20) of the solid cones formed by the spray nozzles (18) in the plane below that intersect the vertical axis of the direct-contact condenser at an angle in the range of 50° to 75°.

12. The device according to any one of claims 7 through 11,
characterized in that
the spray nozzles (17, 18) have the spray pattern of a circular solid cone.

13. The device according to any one of claims 7 through 11,
characterized in that
the spray nozzles (17) arranged in a plane at the head end have the spray pattern of a rectangular solid cone.

14. The device according to any one of claims 7 through 13,
characterized in that
a liquid pressure nozzle (24), preferably a misting nozzle, for atomizing fresh diol into the introduced vapors with the atomization pattern of a circular hollow cone with an angle of divergence in the range of 15° to 45° is mounted in the curved area of the vapor line (2) to the direct-contact condenser (4) upstream from the pipe mouth.

15. The device according to claim 14,
characterized in that
the axis of the atomization pattern of the hollow cone is aligned approximately coaxially with the axis of the direct-contact condenser.

16. The device according to any one of claims 7 through 15,
characterized in that
at least three openings (13, 14) of spray nozzles (17, 18) are provided in each of the planes into which recycled diol is sprayed, and the openings in the spray nozzles in one plane are arranged at an offset with respect to those of the second plane as seen from above, each offset by half the central angle between two neighboring spray nozzles in one plane.

17. The device according to any one of claims 7 through 16,
characterized in that
the cover (3) of the direct-contact condenser (4) and the vapor tube (2) arranged in the inlet opening of the cover are heatable.

18. The device according to any one of claims 7 and 17,
characterized in that
the spray nozzles (17) in the top plane on the head end are positioned in the cover (3) of the direct-contact condenser (4), preferably with thermal insulation.

19. The device according to any one of claims 7 through 18,
characterized in that
the spray nozzles (17, 18) and/or the liquid pressure nozzle (24) are mounted above a lance and/or a valve.

20. The device according to any one of claims 7 and 19,
characterized in that
the end of the vapor tube (2) arranged in the cover (3) of the direct-contact condenser (4) protrudes beyond the inside wall of the cover and has a sharp drip edge (27).

21. The device according to any one of claims 7 through 19,
characterized in that
the inside wall of the cover (3) of the direct-contact condenser (4) has a ring running concentrically outside of the vapor tube (2) as the drip edge.

22. The device according to any one of claims 7 through 21,
characterized in that
the edge of the direct-contact condenser (4) on the foot end has a recess (30) diametrically opposite the drain line (26) for the vapor residues out of the annular space (7).

23. The device according to any one of claims 7 through 21,
characterized in that
the edge of the direct-contact condenser (4) at the foot end is provided with sawtooth profiles either entirely or in sections.

24. The device according to any one of claims 6 through 23,
characterized in that
a peripheral ring nozzle is arranged on the inside of the direct-contact condenser (4) in the upper cylindrical edge area.

25. The device according to any one of claims 7 through 24,
characterized in that
a collecting device (29), preferably a screen basket, for the fine lumps of polymer aggregates washed out with the diol, is arranged in the submerged container (28) of the downpipe (11).
